(19) United States
(12) Patent Application Publication
(10) Pub. No.: US 2023/0143052 A1
(43) Pub. Date: May 11, 2023

(54) METHOD FOR PRESERVING FRESH PRODUCE, SOLID COMPOSITION FOR APPLICATION IN A METHOD FOR PRESERVING FRESH PRODUCE AND PRESERVED FRESH PRODUCE

(71) Applicant: Benjamin Amit SINGH, Bielefeld (DE)

(72) Inventor: Benjamin Amit SINGH, Bielefeld (DE)

(21) Appl. No.: 17/994,625

(22) Filed: Nov. 28, 2022

Related U.S. Application Data
(63) Continuation of application No. 15/836,632, filed on Dec. 8, 2017, now abandoned.

(30) Foreign Application Priority Data
Dec. 21, 2016 (EP) EP16205983

(51) Int. Cl. A23B 7/157; A23B 7/154; A23L 3/358; A23L 3/3544; A23B 7/10

(52) U.S. Cl. CPC A23B 7/157; A23B 7/154; A23L 3/358; A23L 3/3544; A23B 7/10

(57) ABSTRACT

A solid composition for the preservation of food includes a source of potassium cations selected from at least one of potassium carbonate and potassium hydrogen carbonate; and at least one of a source of ascorbate ions and a source of isoascorbate ions, wherein the source of ascorbate ions is selected from at least one of ascorbic acid, a salt of ascorbic acid and acerola or from any other suitable ascorbic acid rich source, wherein the source of isoascorbate is selected from at least one of isoascorbic acid and a salt of isoascorbic acid, and wherein a molar ratio of potassium cations to ascorbate anions and/or potassium cations to isoascorbate anions in the solid composition is within the range from 1.00:0.95 to 1.00:0.50, preferably 1.00: ≤0.78 to 1.00:0.50.

### CROSS-REFERENCES TO RELATED APPLICATIONS

This application claims the priority of European Patent Application, Serial No. 16 205 983.6, filed Dec. 21, 2016, pursuant to 35 U.S.C. 119(a)-(d), the content of which is incorporated herein by reference in its entirety as if fully set forth herein.

### BACKGROUND OF THE INVENTION

The present invention relates to the technical field of food preservation, in particular to the preservation of fresh produce, such as fruit and vegetables.

The invention relates to a solid composition, an aqueous solution of solid composition, a method for preserving fresh produce by applying the solution of solid composition, and fresh produce preserved by application of this method.

The following discussion of related art is provided to assist the reader in understanding the advantages of the invention, and is not to be construed as an admission that this related art is prior art to this invention.

Food preservation involves preventing the growth of undesired micro-organisms, slowing of oxidation, and inhibition and/or reversal of processes leading to visual deterioration, such as the browning reaction of cut fruit. There are many processes applicable to preserve food, which may involve various food preservation methods. In many processes, the character of the processed food regarding appearance and taste is fundamentally changed. In contrast to such processes, it is desirable in many cases to make food more durable and to extend its storability while preserving as many characteristics, such as flavor, texture, scent and optical appearance, as possible.

A method for the preservation of fresh produce, in particular of cut fruit and vegetables, is described in EP 1 659 887, which relies on a combination of a preservative cation selected from a wide range of metal ions as well as ammonium ion or mixtures thereof, and ascorbate ions or erythorbate ions dissolved in water. The solution is applied to the fresh produce to extend shelf-life, preserving the texture, flavor, appearance, crispness, and color of the fresh produce, particularly the exposed surface of the fresh produce. The application of metal ascorbates or combinations of ascorbic acids and metal salts in treating fruit, vegetables and other foodstuff for reduction of microbial contamination, prevention of coloring and preservation is also disclosed in JP 06-181 684, EP-A-0 141 875 and WO 0030460.

It would be desirable and advantageous to provide an improved preservation agent and an improved method for the preservation of fresh produce. It would be in particular desirable and advantageous to provide a new agent and a method for the preservation of fresh produce with improved performance compared to known products and methods regarding browning inhibition and/or browning reversal, maintenance of texture and crispness as well as taste properties when being applied to fresh produce.

### SUMMARY OF THE INVENTION

### Solid Composition

According to one aspect of the present invention a solid composition includes a source of potassium cations selected from at least one of potassium carbonate and potassium hydrogen carbonate; and at least one of a source of ascorbate ions and a source of isoascorbate ions, said source of ascorbate ions being selected from at least one of ascorbic acid, a salt of ascorbic acid and acerola or from any other suitable ascorbic acid rich source, said source of isoascorbate being selected from at least one of isoascorbic acid and a salt of isoascorbic acid, wherein a molar ratio of potassium cations to ascorbate anions and/or potassium cations to isoascorbate anions in the solid composition is within the range from 1.00:0.95 to 1.00:0.50, preferably 1.00: ≤0.78 to 1.00:0.50.

Currently preferred is that the molar ratio of potassium cations to ascorbate anions and/or isoascorbate anions in the solid composition is within the range from 1.00:0.90 to 1.00:0.60. Even more preferred is a ratio of potassium cations to ascorbate anions and/or isoascorbate anions in the solid composition 1.00:0.80 to 1.00:0.70, and most a ratio of 1.00:0.75 to 1.00:0.70.

According to another advantageous feature of the invention, the molar ratio of potassium cations to ascorbate anions and/or isoascorbate anions in the solid composition is within the range from 1.00: ≤0.78 to 1.00:0.50; more preferably 1.00: ≤0.78 to 1.00:0.60, even more preferably 1.00: ≤0.78 to 1.00:0.70, and most preferably 1.00: ≤0.78 to 1.00:0.70.

According to another advantageous feature of the invention, the molar ratio of potassium cations to ascorbate anions and/or isoascorbate anions in the solid composition is 1.00:0.75 to 1.00:0.70, or 1.00:0.74 to 1.00:0.71, or 1.00 to 0.73.

In the solid composition according to the invention, the source of potassium ions may be potassium carbonate, potassium hydrogen carbonate or a mixture thereof. The use of potassium carbonate as the source of potassium ions is preferred.

In the solid composition according to the invention, the source of ascorbate ions may be ascorbic acid or a salt of ascorbic acid. The source of isoascorbate ions may be isoascorbic acid or a salt of isoascorbic acid. It is also possible to use acerola as a source of ascorbate ions or any other suitable ascorbic acid (vitamin C) rich source.

If a salt of ascorbic acid and/or isoascorbic acid is used, it is preferably a metal salt of ascorbic acid or isoascorbic acid, or mixtures thereof, more preferably an alkali or earth alkali metal salt of ascorbic acid or isoascorbic acid, or mixtures thereof, most preferably potassium ascorbate or potassium isoascorbate, or mixtures thereof. The use of ascorbic acid as source of ascorbate ions is particularly preferred.

In a preferred embodiment according to the invention, a combination of potassium carbonate and ascorbic acid is used to provide the potassium cations and the ascorbate anions contained in the solid composition.

Optionally, the solid composition according to the invention furthermore contains one or more excipients suitable for the use in food, selected from the group of antiadherents, binders, colors, flavors, lubricants, preservatives, sweeteners, such as in particular listed in governmental regulations, for example in the German Ordnance on Registration of Additives (ZZuIV), according to the German Food- and Feed Code (LFGB), or classified as GRAS (generally recognized as safe) food substances by the FDA.

In a preferred embodiment of the invention, the solid composition contains less than 30 weight-% of an excipient or excipients, more preferably less than 20 weight-%, even more preferably less than 10 weight-%, and most preferably less than 5 weight-% of excipients.

According to the present invention, the term solid composition relates to a mixture of components in solid state, wherein the particle size and particle shape of each component are not limited in any way. The solids may have the form of powder, grains, granules or chunks, without being limited thereto.

In a preferred embodiment of the invention, the content of chloride-anion containing salts in the solid composition is ≤20.0 weight-%, preferably ≤10.0 weight-%, more preferably ≤5 weight-%, even more preferably ≤3.5 weight-%, such as particularly preferred <3.5 weight-%, more preferably ≤3.0 weight-%, more preferably ≤2.5 weight-%, more preferably ≤2.0 weight-%, more preferably ≤1.5 weight-%, more preferably ≤0.5 weight-%.

In a preferred embodiment of the invention, potassium chloride and any chloride anion-containing salts are excluded from the solid composition.

### Solution of the Solid Composition

According to another aspect of the invention, a solution of the solid composition. In such solution the solid composition is dissolved in a single solvent or a mixture of solvents, wherein solvents used other than water have to be water-miscible and suitable as food additives, such as e.g. approved by governmental regulations, for example in the German Ordnance on Registration of Additives (ZZuIV), according to the German Food- and Feed Code (LFGB), or classified as GRAS (generally recognized as safe) food substances by the FDA.

Examples of such solvents are glycerol and propylene glycol, which are fully miscible with water.

The solution of the solid composition is generally an aqueous solution. The most preferred solvent is water. Preferably, water is used as sole solvent to prepare a solution of solid composition by dissolution of solid composition.

In the context of the present invention, water includes drinking water as supplied either publicly by local government authorities or privately by the food business itself.

In the solution of the solid composition according to the present invention, the molar ratio of potassium cations to ascorbate anions and/or isoascorbate anions in the solution is within the range from 1.00:0.95 to 1.00:0.50; more preferably 1.00:0.90 to 1.00:0.60, even more preferably 1.00:0.80 to 1.00:0.70, and most preferably 1.00:0.75 to 1.00:0.70.

In a further embodiment of the solution of the solid composition according to the invention the molar ratio of potassium cations to ascorbate anions and/or isoascorbate anions in the solution is within the range from 1.00: ≤0.78 to 1.00:0.50; more preferably 1.00: ≤0.78 to 1.00:0.60, even more preferably 1.00: ≤0.78 to 1.00:0.70, and most preferably 1.00: ≤0.78 to 1.00:0.70.

In a preferred embodiment according to the invention, the content of chloride-anion containing salts in the solution of the solid composition is ≤3.5 weight-%, preferably below (<) 3.5 weight-%, preferably ≤3.0 weight-%, preferably ≤2.5 weight-%, more preferably ≤2.0 weight-%, even more preferably ≤1.5 weight-%, even more preferably ≤1.0 weight-%, and most preferably ≤0,5 weight-%. From the given ranges of chloride-anion containing salts in the solution the respective chloride-anion concentrations can be calculated by a skilled person. The respective chloride-anion concentrations are likewise excluded from the solution of the present invention.

In the intended use according to the present invention, the presence of chloride anions causes a salty taste, which may impair the quality of the preserved fresh produce when the chloride anion content exceeds a certain proportion of the solution of the solid composition.

In a preferred embodiment, potassium chloride and any chloride anion-containing salts or chloride anions are excluded from the solution of the solid composition applied in the method for fresh produce preservation

Therein, traces of chloride anions stemming e.g. from drinking water or from salts other than chloride anion-containing salts (e.g. as impurities) used for the preparation of the solution of the composition shall be exempted from the exclusion of potassium chloride and any chloride anion-containing salts or chloride anions in the solution of the present invention.

In the context of present invention, the exclusion of potassium chloride does not apply to potassium chloride generated from chloride anions present in the solvent used to prepare the solution of solid composition, e.g. as traces in drinking water, and potassium cations from the solid composition, having a different counter-ion in the solid composition.

In the present invention both potassium cations stemming from potassium salts serving as potassium ion sources as well as potassium salts stemming from compounds serving as ascorbate or isoascorbate sources are considered in the determination of the ratio of potassium ions to ascorbate and/or isoascorbate ions, while potassium cations stemming from drinking water used for the preparation of the solution of the solid composition are not considered in the determination of the ratio of potassium ions to ascorbate and/or isoascorbate ions.

The solution may be present as a ready-to-use solution for preserving food as defined herein. Such ready-to-use solutions may comprise further additives in accordance with the above mentioned regulations. As suitable additive for a ready-to-use solution preservatives are mentioned.

Use of the Solid Composition and the Solution thereof

The solid composition and the solution of the solid composition according to the present invention are a composition for application in food preservation.

In the context of the present invention, the term food preservation means measures to enhance durability and storability of food. It means to prevent the growth of micro-organisms, as well as to, slow down the oxidation of food and its constituents. Food preservation also includes inhibition and/or reversal of visual deterioration, such as the enzymatic browning reaction of fruit and vegetables, especially after they are cut for food preparation, and measures to maintain the texture and flavor of food, in particular of fresh produce, as defined below.

The solid composition and the solution of the solid composition according to the present invention are in particular useful for inhibiting and/or reversing visual deterioration, such as in particular enzymatic browning reactions of fruit and vegetables, especially after they are cut for food preparation.

The solid composition and the solution of the solid composition according to the present invention are used for preserving food as defined herein and are thus applied in a method for preserving fresh produce as defined in detail below.

### Method for Preserving Food

According to another aspect of the present invention, a method for preserving fresh produce, comprising the steps of providing a solution of a solid composition, said solid composition comprising a source of potassium cations selected from at least one of potassium carbonate and potassium hydrogen carbonate, and at least one of a source of ascorbate ions and a source of isoascorbate ions, said source of ascorbate ions being selected from at least one of ascorbic acid, a salt of ascorbic acid and acerola or from any other suitable ascorbic acid rich source, said source of isoascorbate being selected from at least one of isoascorbic acid and a salt of isoascorbic acid, wherein a molar ratio of potassium cations to ascorbate anions and/or potassium cations to isoascorbate anions in the solid composition is within the range from 1.00:0.95 to 1.00:0.50, preferably 1.00: ≤0.78 to 1.00:0.50, and wherein potassium cations stemming from drinking water used for the preparation of the solution of the solid composition are not considered in the determination of the ratio of potassium ions to ascorbate and/or potassium ions to ascorbate to isoascorbate ions; and applying the solution to the fresh produce.

According to another advantageous feature of the invention, the method further includes the step of providing the solid composition and mixing the solid composition with a solvent to obtain the solution of the solid composition.

In an alternative embodiment of the method according to the invention the molar ratio of potassium cations to ascorbate anions and/or isoascorbate anions in the solution of the solid composition is within the range from 1.00: ≤0.78 to 1.00:0.50; more preferably 1.00: ≤0.78 to 1.00:0.60, even more preferably 1.00: ≤0.78 to 1.00:0.70, and most preferably 1.00: ≤0.78 to 1.00:0.70.

The step for providing the solid composition according to the invention can be performed by mixing of the compounds constituting the solid composition, wherein any conventional mixing device suitable for mixing solids, such as planetary mixer, shaker-mixer, drum mixer can be used.

The step for providing a solution of the solid composition according to the invention can be performed immediately prior to use of the solution in step, i.e., immediately prior to the applying step, or it can be performed in advance, and the solution of the solid composition can be stored until it is used.

In a preferred embodiment of the method according to the invention, the solution applied for the preservation of fresh produce contains 90.0 to 98.0 weight-% of water, more preferred 92.0 to 96.0 weight-% of water, even more preferred 93.0 to 95.0 weight-% of water and most preferred 93.5 to 94.5 weight-% of water.

In a preferred embodiment of the method for preserving fresh produce according to the invention, the solution of the solid composition contains 0.01 to 5.0 weight-% of potassium ions, more preferably 0.2 to 4.0 weight-%, even more preferably 0.75 to 2.5. weight-%, and most preferably 1.0 to 1.5 weight-% of potassium ions.

In a preferred embodiment of the method for preserving fresh produce according to the invention, the solution of the solid composition contains 0.01-10.0 weight-% of ascorbate or isoascorbate ions, more preferably 1.0 to 8.0 weight-%, even more preferably 2.5 to 6.0 weight-%, and most preferably 3.5 to 4.5 weight-% of ascorbate or isoascorbate ions. If acerola or any other suitable ascorbic acid (vitamin C) rich source is used, the amounts thereof are calculated respectively to provide the above mentioned amounts of ascorbate or isoascorbate ions.

It is further preferred, that the pH value of the solution of the solid composition according to the present invention is within the range from 5.0 to 9.0, more preferably from 5.5 to 8.5, even more preferred from 6.0 to 8.0, and most preferred from 6.5 to 7.5.

Particularly preferred is a pH neutral solution, in particular over acidic and strongly acidic solutions.

In the context of the present invention, the pH value of the solution is measured with common laboratory pH meter for aqueous solutions at room temperature (20° C.±5° C.), making use of electrochemical determination of pH value.

In a preferred embodiment of the invention, the solution of the solid composition is applied to the fresh produce by spraying, sprinkling, dousing, dipping or immersion, which corresponds to step (d) of the method described above.

The term spraying according to the invention relates to any technical process in which an aerosol is created and aimed at the fresh produce to be conserved. This may be by a pump spray system or a propellant-based spray system. The droplet size of the solution of the solid composition is not limited to any size range, but preferably the droplets are of microscopic size.

The term sprinkling according to the invention relates to any technical process in which drops and/or droplets of the solution of the solid composition (C) are sprinkled onto the fresh produce, for instance by a sprinkler system.

The term dousing according to the invention relates to any technical process in which the solution of the solid composition is doused or poured onto the fresh produce.

The technical processes referred to as spraying, sprinkling or dousing can be applied to the fresh produce being positioned on a grid, in a tray or on a conveyor belt, but are in no way restricted by these modes of application.

The terms dipping and immersion according to the invention relate to any technical process in which the fresh produce is brought into a reservoir of the solution of the solid composition so that the entire surface of the fresh produce is at least temporarily covered by the solution, or so that the fresh produce is floating on the surface of the solution of solid composition.

Furthermore, any other means suitable for covering the surface of the fresh produce to be preserved with the solution of solid composition (C) can be applied in the method according to the invention.

In the context of the present invention the term “food” relates to any food which may be prone to oxidation. The invention particularly relates to fresh food, more particularly to fresh produce.

In the context of present invention, the term “fresh produce” principally comprises fresh fruit and vegetables. Primarily, but not exclusively, such fresh fruit and vegetables are farm-grown.

In the context of present invention, the term “fresh produce” also implies that the fruits and vegetables are either in the same state as they were harvested, or have been peeled, sliced, chopped or submitted to any means for reducing size or providing bite-size portions of fruits and vegetables, such as slicing, chopping, cutting or peeling.

The present invention particularly relates to the application of the solid composition, in particular in the form of its solution, to fresh fruit and vegetables, in particular to apples, pears, potatoes, carrots, lettuce, avocados, leeks, rhubarb, onions, basil, melons, pineapple, eggplant, rutabaga, kale, cherries, strawberries, mushrooms, nectarines, peaches, kiwi, garlic, peppers, tomatoes fennel, lemons, oranges, apricot, asparagus, beans, peas, broccoli, cauliflower, Brussel sprouts, cabbage, celery, chard, corn, endive, herbs, okra, dragon fruit, parsley, chili, beetroot, turnip, ginger, radish, squashes, courgette, pumpkin, artichoke, sweet potato, zucchini and watercress.

Preferably the solid composition, in particular in the form of its solution is applied to apples, pears, potatoes, carrots, avocados, leeks, rhubarb, onions, melons, pineapple, eggplant, rutabaga, kale mushrooms, nectarines, peaches, kiwi, garlic, peppers, tomatoes fennel, lemons, oranges, apricot, asparagus, broccoli, cauliflower, parsley, chili, beetroot, turnip, ginger, radish, squashes, courgette, pumpkin, artichoke, sweet potato and zucchini.

The application to pears and apples is even more preferred, most preferred is the application to apples.

In the context of present invention, fresh produce taxonomically belonging to fungi, such as champignons, mu err, porcino, chanterelle and any other mushrooms, are considered to be comprised by the term vegetables.

### BRIEF DESCRIPTION OF THE DRAWING

Other features and advantages of the present invention will be more readily apparent upon reading the following description of currently preferred exemplified embodiments of the invention with reference to the accompanying drawing, in which

FIG. 1: shows a bar graph displaying browning percentage of Example 2 and Comparative Examples 1, 2 and 3 after 21 days.

### DETAILED DESCRIPTION OF PREFERRED EMBODIMENTS

Throughout all the FIGURES, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The present invention is further illustrated by the following examples, without being limited thereto.

### Example 1: Solid Composition (C)

63 g of potassium carbonate (Food Grade, granular from Altair Chimica S.p.A.) and 117 g of ascorbic acid (Ph. Eur. Grade, DSM Nutritional Products Ltd.) were thoroughly mixed to provide the solid composition (C).

### Example 2: Solution of Solid Composition (C)

The dry mixture according to Example 1 was dissolved in 3 liter of drinking water to provide a solution of the solid composition according to Example 1.

### Example 3: Solution of Solid Composition (C)

63 g of potassium carbonate and 117 g of ascorbic acid were mixed with 2820 g of water to prepare a 6% solution (w/w).

### Example 4: Solution of Solid Composition (C)

63 g of potassium carbonate and 117 g of ascorbic acid were topped off with water until the solution level reached 3000 ml to make a 6% solution (w/v).

### Comparative Example 1

15.9 g of potassium carbonate (Food Grade, granular from Altair Chimica S.p.A.) and 40 g of ascorbic acid (Ph. Eur. Grade, DSM Nutritional Products Ltd.) were thoroughly mixed to provide a comparative solid composition.

167,7 g of the comparative solid composition as described above were dissolved in 2832,30 g water. Thus, a preservative solution of the comparative solid composition containing 4.0 weight-% (w/w) of ascorbic acid and 1.59 weight-% (w/w) of K₂CO₃ was obtained.

### Comparative Example 2

35 g of potassium chloride (Ph. Eur. Grade, Dr. Lohmann Diaclean GmbH) and 65 g of ascorbic acid (Ph. Eur. Grade, DSM Nutritional Products Ltd. were thoroughly mixed to provide a comparative solid composition.

300 g of the comparative solid composition obtained as described above were dissolved in 2700 g water. Thus, a preservative solution of the comparative solid composition containing 6.5 weight-% of ascorbic acid and 3.5 weight-% of KCl was obtained.

### Comparative Example 3

11 g of potassium hydrogen carbonate (Ph. Eur. Grade, crystalline, Caesar & Loretz GmbH) and 40 g of ascorbic acid (Ph. Eur. Grade, DSM Nutritional Products Ltd.) were thoroughly mixed.

153 g of the comparative solid composition obtained as described above were dissolved in 2847 g water. Thus, a preservative solution of the comparative solid composition containing 4.0 weight-% of ascorbic acid and 1.1 weight-% of KHCO₃ was obtained.

### Application Test on Cut Jonagold Apples (Wedges)

Tested compositions:
Solution according to Example 2 and Comparative Examples 1, 2 and 3.

In each treatment, Jonagold apples were rinsed with water and cut into wedges using 19 mm NEMCO corer (55550-8C). Within 30 seconds the thus obtained wedges were dipped into a preservative solution for 2 minutes in a vessel in which dipping is performed, then the wedges were removed from the solution and stored in standard clam shell packages (Inline Plastics Corp, Safe-T-Fresh®) at a storage temperature of 4-6° C. (in a stainless steel refrigerator).

21 days after production, the browning percentage (browning %) of the samples of each treatment was evaluated. Therein, the browning percentage indicates the proportion of apple slices without browning. This means that a higher browning percentage constitutes a better anti-browning performance.

The browning percentage is determined by the equation (I):

$$100 - ( \frac{\begin{matrix}number of apple pieces \\ affected by browning\end{matrix}}{total number of apple pieces} ) \times 100 = browning percentage [ \% ] \qquad ( I )$$

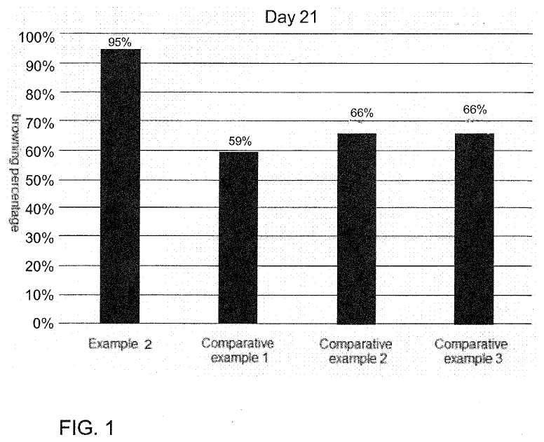

The results of the browning percentages are shown in the following Table 1 and in FIG. 1.

TABLE 1

| | | | Com- | Com- | Com- |
|---|---|---|---|---|---|
| | | | parative | parative | parative |
| Experiment | | Example 2 | Example 1 | Example 2 | Example 3 |
| Com- | Ascorbic | 3.9 weight- | 4.0 weight- | 6.5 weight- | 4.0 weight- |
| ponents | acid | % | % | % | % |
| | K₂CO₃ | 2.1 weight- | 1.59 weight- | — | — |
| | | % | % | | |
| | KCl | — | — | 3.5 weight- | — |
| | | | | % | |
| | KHCO₃ | — | — | — | 1.1 weight- |
| | | | | | % |
| Solvent | | water | water | water | water |
| | After 21 | 95% | 59% | 66% | 66% |
| | days | | | | |

What is claimed as new and desired to be protected by Letters Patent is set forth in the appended claims and includes equivalents of the elements recited therein:

1-17. (canceled)

18. A solid composition for the preparation of an aqueous solution for application to fresh produce, said solid composition comprising:
a source of potassium cations comprising potassium carbonate; and
at least one of a source of ascorbate ions and a source of isoascorbate ions, wherein said source of ascorbate ions is at least one selected from the group consisting of ascorbic acid, a salt of ascorbic acid, and acerola, and
said source of isoascorbate is selected from at least one of isoascorbic acid and a salt of isoascorbic acid, wherein
a molar ratio of potassium cations to ascorbate anions and/or
a molar ratio of potassium cations to isoascorbate anions in the solid composition is within the range from 1.00:0.95 to 1.00:0.50.

19. The solid composition of claim 18, wherein
a molar ratio of potassium cations to ascorbate anions and/or
a molar ratio of potassium cations to isoascorbate anions in the solid composition is within the range of from 1.00:0.78 to 1.00:0.50.

20. The solid composition of claim 18, wherein a content of chloride-anion containing salts in the solid composition is ≤20 weight-%.

21. The solid composition of claim 18, excluding potassium chloride and all chloride anion-containing salts.

22. The solid composition of claim 18, further comprising one or more excipients suitable for use in food.

23. A method of preserving food comprising contacting the solid composition of claim 18 with said food.

24. An aqueous solution, comprising a solvent and the composition of claim 18.

25. A method for preserving fresh produce, comprising contacting the aqueous solution of claim 24 with said produce, wherein
potassium cations not provided by said solid composition are not considered in the determination of the ratio of potassium ions to ascorbate and/or potassium ions to ascorbate to isoascorbate ions.

26. The method of claim 25, further comprising preparing the solution by dissolving the solid composition in at least one solvent.

27. The method of claim 26, wherein the at least one solvent is water.

28. The method of claim 25, wherein a content of chloride-anion containing salts in the solution of the solid composition is <3.5 weight-%.

29. The method of claim 25, wherein
the solution of the solid composition excludes potassium chloride and any chloride-anion-containing salts, solvent impurities excepted.

30. The solution of claim 24, wherein the solution of the solid composition contains 90.0 to 98.0 weight-% of water.

31. The solution of claim 24, wherein the solution of the solid composition contains 92.0 to 96.0 weight-% of water.

32. The solution of claim 24, wherein the solution of the solid composition comprises 0.01 to 5.0 weight-% of potassium ions and 0.01-10.0 weight-% of ascorbate or isoascorbate ions.

33. The solution of claim 24 having a pH value within the range from 5 to 9.

34. The solution of claim 24 having a pH value within the range from 5.5 to 8.5.

35. The method of claim 25, wherein the solution of the solid composition is applied to the fresh produce by spraying, sprinkling, dousing, dipping or immersion.

36. The method of claim 25, wherein the solution of the solid composition is applied to at least one of fresh fruit and fresh vegetables, selected from the group consisting of apples, pears, potatoes, carrots, lettuce, avocados, leeks, rhubarb, onions, basil, melons, pineapple, eggplant, rutabaga, kale, cherries, strawberries, mushrooms, nectarines, peaches, kiwi, garlic, peppers, tomatoes fennel, lemons, oranges, apricot, asparagus, beans, peas, broccoli, cauliflower, Brussel sprouts, cabbage, celery, chard, corn, endive, herbs, okra, dragon fruit, parsley, chili, beetroot, turnip, ginger, radish, squashes, courgette, pumpkin, artichoke, sweet potato, zucchini and watercress.

37. A fresh produce, preserved by the method of claim 36.
